(19) United States
(12) Patent Application Publication
(10) Pub. No.: US 2024/0292789 A1
(43) Pub. Date: Sep. 5, 2024

(54) A MULCHER

(71) Applicant: Andrew Martin, Whitley Bay (GB)

(72) Inventor: Andrew Martin, Whitley Bay (GB)

(21) Appl. No.: 18/260,261

(22) PCT Filed: Jan. 6, 2022
(86) PCT No.: PCT/IB2022/050089

§ 371 Date: Jul. 3, 2023

(30) Foreign Application Priority Data
Jan. 5, 2021 (GB) 2100107.8

(51) Int. Cl. A01G 3/00; B02C 18/22; B02C 23/16

(52) U.S. Cl. CPC A01G 3/002; B02C 18/2216; B02C 18/2291; B02C 2023/165

(57) ABSTRACT

A mulcher includes a hopper, having an inlet end and an outlet end, the hopper configured to receive vegetative debris via the inlet end; a chipper unit having an outer casing and an inlet passing therethrough, the inlet connected to the hopper outlet end to in use receive the vegetative debris within the casing, the chipper unit further comprising a cutting means located within the casing and configured to chip and/or mulch vegetative debris within the chipper unit; an outlet grid, the chipper unit and outlet grid configured so that the outlet grid forms an outlet for the vegetative debris within the casing, the outlet grid 13 and cutting means mutually configured so that the grid is located substantially directly adjacent to the cutting means in use, the cutting means configured so that in use at least part of the vegetative debris is forced through the outlet grid.

### FIELD

The present invention relates to a mulcher for garden debris. More particularly, the present invention relates to a mulcher having a fast-rotating drum. Even more particularly, the present invention relates to a mulcher having a high-speed drum and a debris screen directly adjacent to the drum. The present invention also relates to a discharge screen for use with a mulcher.

### BACKGROUND

Wood chippers and mulchers are well known devices used to process fallen or cut branches and/or similar debris or refuse (vegetative debris), turning this into chips and/or mulch. A typical wood chipper/mulcher is made up of three main parts: a hopper, a chipper unit, and discharge chute. Debris such as branches, etc is manually loaded into the hopper, which is usually set upright at an angle so that debris feeds under gravity into the chipper unit. A typical chipper unit comprises a generally cylindrical grinding chamber, within which is fitted a slotted/perforated drum having a radius slightly smaller than that of the chamber, the drum rotating within the chamber. The chamber is aligned so that it is in a plane at an angle to the feed direction of the wood, so that as the wood/debris enters the chipper unit the branch, foliage, or other item is progressively cut along its length into smaller sections by the drum as it is fed into the chamber. Over a short period of time the debris is cut into small fragments—that is, chipped or mulched. The mulch or chips then pass out of the chipper unit through a perforated debris or discharge screen. Examples of typical discharge screens are shown in FIGS. 1 and 2. Chips or pieces of debris fall through the screen when they have been cut to a sufficiently small enough size to fall through the screen. However, allowing the particles to free fall through the screen can lead to clogging/bridging of the screen-when the particles free fall through the screen this can start a build-up of stationary particles just below the screen, leading to full blocking.

As shown in FIGS. 1 and 2, typical screens have apertures that are regularly-shaped holes—hexagonal, circular, etc, and of a variety of sizes. This allows the production of mulch or chips of certain sizes, which can then be used for different purposes—e.g. wood chips tend to be larger and chunkier than mulch and tend to last longer without compacting. These therefore provide a cleaner ground cover that is preferable for use in areas with large amounts of foot traffic, such as playgrounds and trails. Mulch is more suitable for use in gardens to provide nutrients to the soil, insulate plant roots, and retain moisture in the soil, as it is finer than wood chips and is predisposed to break down faster and provide more nutrition to plants, which makes it better for use in garden areas.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a high-speed mulcher which goes some way to overcoming the abovementioned disadvantages or which at least provides the public or industry with a useful choice.

It is a further object of the present invention to provide a discharge screen which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a mulcher, comprising: a hopper, having an inlet end and an outlet end, the hopper configured to receive vegetative debris via the inlet end; a chipper unit having an outer casing and an inlet passing therethrough, the inlet connected to the hopper outlet end to receive the vegetative debris within the casing, the chipper unit further comprising a cutting means located within the casing and configured to chip and/or mulch vegetative debris within the chipper unit; an outlet grid, the chipper unit and outlet grid configured so that the outlet grid forms an outlet for the vegetative debris within the casing, the outlet grid and cutting means mutually configured so that the grid is located substantially directly adjacent to the cutting means in use, the cutting means configured so that in use at least part of the vegetative debris is forced through the outlet grid.

In an embodiment, the outlet grid comprises a plate with a plurality of elongate slots formed therethrough.

In an embodiment, the elongate slots are formed to substantially follow the perimeter of the casing.

In an embodiment, four substantially identical slots are formed across the width of the plate.

In an embodiment, the cutting means comprises at least one rotating blade having an edge aligned substantially parallel to the axis of rotation, and a base block located within the chipper unit and configured so that vegetative debris moves over the base block into the blade(s), the blade(s) rotating directly adjacent to the base block.

In an embodiment, the cutting means further comprises a rotating drum having a plurality of blades at the perimeter thereof.

In an embodiment, the outlet grid extends substantially one-third of the distance around the perimeter of the chipper unit.

In an embodiment, the outlet grid is located on the chipper unit so as to face at least partly downwards.

In an embodiment, the outer casing of the chipper unit further comprises an upwardly-facing upper discharge aperture.

In an embodiment, the discharge aperture is configured so that a blanking plate can be connected to the chipper unit to block the discharge aperture.

In an embodiment, the outlet grid and chipper drum are configured so that the outlet grid can be removed and replaced with a blanking plate.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a perspective view to the front and one side of a known prior art chipper/mulcher and examples of the types of discharge screens that can be fitted.

FIG. 2 shows further examples of types of known, prior art discharge screen.

FIG. 3 shows a perspective side view of a high-speed mulcher according to an embodiment of the invention, the mulcher comprising a hopper, a chipper unit, an upper discharge chute, a lower discharge chute, and a wheeled base section on which the hopper, chipper unit, upper discharge chute, and lower discharge chute are mounted.

FIG. 4 shows a close-up perspective view of the chipper unit, motor and lower discharge chute of the mulcher of the embodiment of FIG. 3, showing detail of a discharge grid located inside the chipper unit in use, a cutting drum that in use is located inside the chipper unit not shown.

FIG. 5 shows a close-up detail view of the chipper unit and discharge grid of the embodiment of mulcher of FIGS. 3 and 4.

FIG. 6 shows a close-up perspective view of the chipper unit, motor and lower discharge chute of the mulcher of FIGS. 3 to 5, with the hopper and cutting drum not present.

FIG. 7 shows a close-up perspective view from underneath of the chipper unit and discharge grid, with the hopper and discharge chutes not present, and the cutting drum not present.

FIG. 8 shows a close-up perspective view of the chipper unit with the cutting drum located in the chipper unit, the outer flange not shown, the lower discharge chute of the mulcher of the embodiment connected to the chipper unit.

FIG. 9 shows a close-up perspective view of the chipper unit from the same angle as FIG. 8 with the cutting drum located in the chipper unit, the outer flange not shown, the upper discharge chute of the mulcher of the embodiment connected to the chipper unit.

FIG. 10 shows a close-up perspective view of the chipper unit from the same angle as FIG. 8 and FIG. 9 with the cutting drum located in the chipper unit, the outer flange not shown, the upper and lower discharge chutes of the mulcher of the embodiment both connected to the chipper unit

FIG. 11 shows the inner face of the lower discharge chute where this is in use located immediately adjacent to the discharge grid, showing detail of a polishing or scouring effect on the inner surface caused by the force and movement of mulched material forced through the discharge grid.

### DETAILED DESCRIPTION

Embodiments of the invention, and variations thereof, will now be described in detail with reference to the figures.

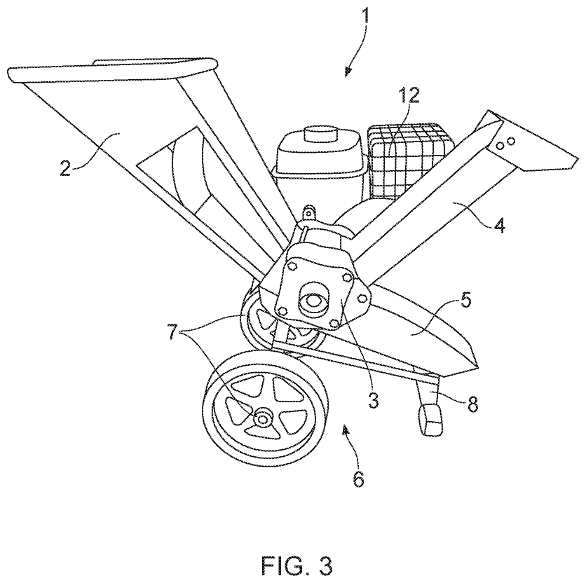

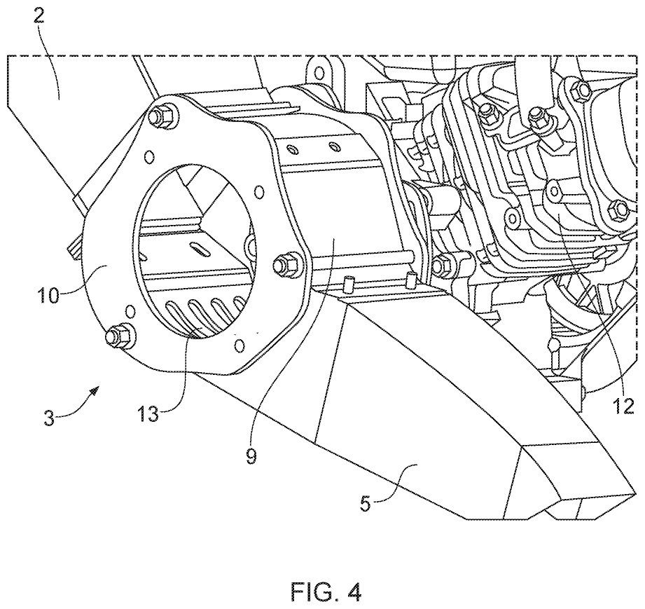

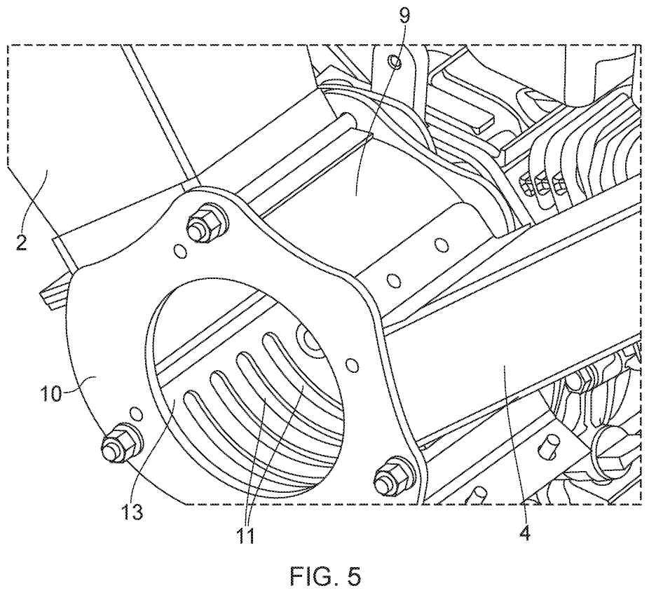

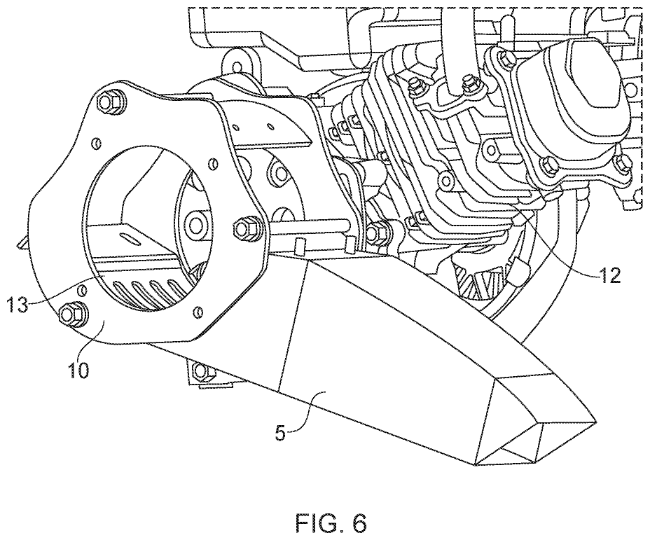

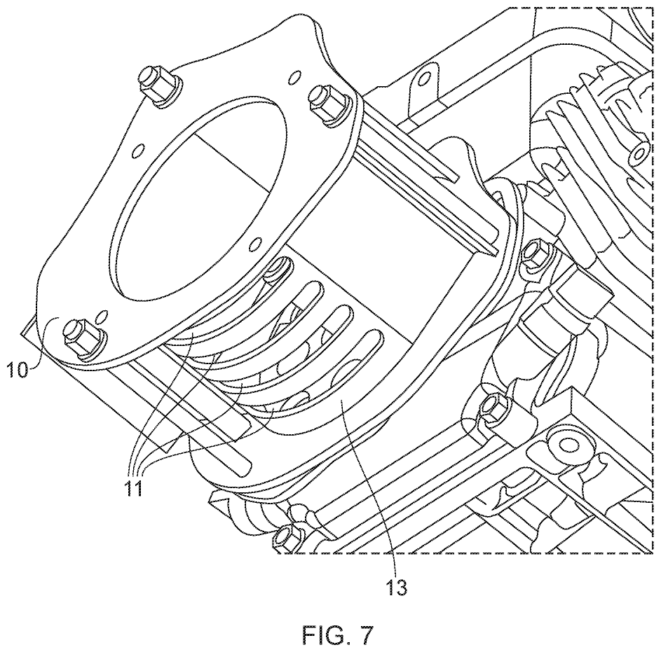

As shown in FIG. 3, in an embodiment, the high-speed mulcher 1 comprises three main parts or subsections: a hopper 2, a chipper unit 3, an upper discharge chute 4, and a lower discharge chute 5. These parts are connected to one another to form a single unit, which is located on a base section 6 that comprises a pair of wheels 7 at one end and a support section 8 at the other end, allowing the mulcher 1 to be transported in a similar manner to a wheelbarrow, by lifting the support section up so that it pivots around the axis of the wheels 7, and then wheeling it on the wheels. A motor 12 is mounted on the top of the base section 5, to one side of the chipper unit 3, to power the chipper unit 3 in use.

The hopper 2 is configured to receive vegetative debris, and comprises a funnel shape, rectangular in cross-section, between one and two metres long, with a wide, open mouth end large enough to allow medium-sized branches and similar debris to be easily fed into the wide or intake end. In the preferred embodiment the intake end is 40 cm across the longer side. However, the hopper 2 can be changed or swapped out for one of a different size (larger or smaller), as required. The narrower open lower end is connected to an entry aperture at one side of the casing that forms the outer part of the chipper unit 3, in the upper-left quadrant of the casing of the chipper unit 3, so that branches and debris exiting the hopper 2 at the lower end of the hopper 2 feed into the chipper unit 3.

The chipper unit 3 comprises a casing forming a generally cylindrical chamber 9, with a flange 10 at each end of the casing. The central axis of the chamber 9 is arranged substantially horizontally. Vegetative debris from the hopper 2 enters the chamber 9 at the upper-left quadrant via the entry aperture.

The upper discharge chute 4 comprises an elongate tube, generally rectangular or square viewed end-on, that is located substantially directly across from the hopper.

The upper discharge chute 4 is connected to an upper exit aperture of the chamber 9 in the upper-right quadrant of the chamber 9 that allows debris to be fed into the upper discharge chute 4. The upper discharge chute 4 extends at an angle upwards and away from the chipper unit 3.

The lower discharge chute 5 comprises a tubular member, generally rectangular in cross-section, that tapers slightly from a wide entry point to a narrower free end. The open inner end is connected to the chamber 9 via a lower exit aperture in the chamber 9, in the lower-right quadrant of the chamber 9. The lower discharge chute 5 is arranged to extend outwards and downwards from the chamber 9.

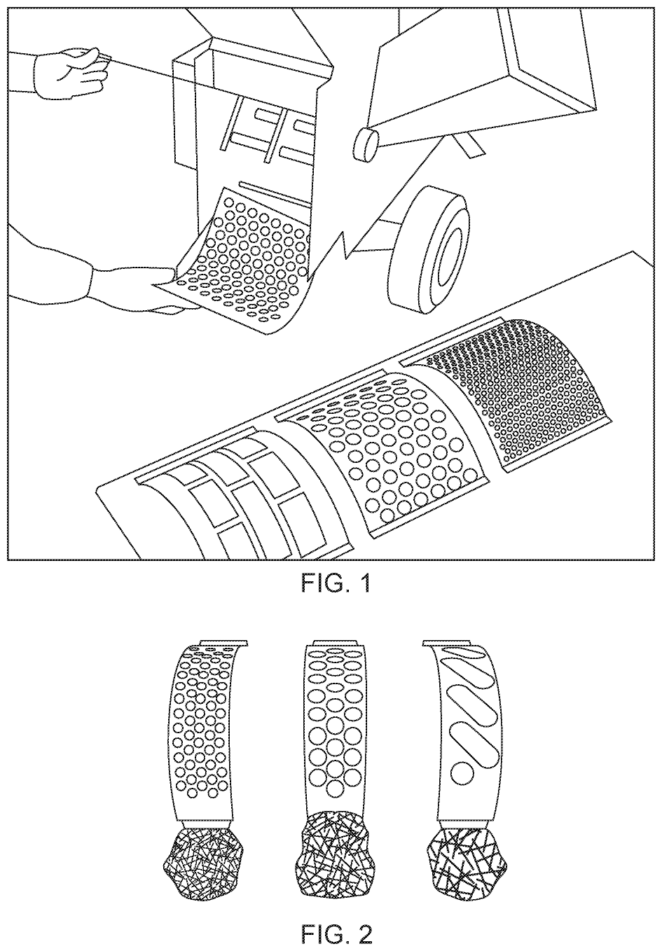

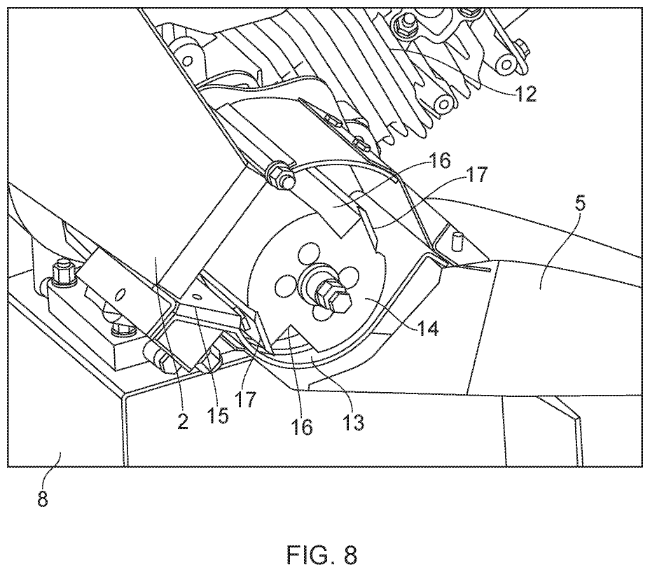

The interior of the chamber 9 contains a rotating chipper drum 14. The drum 14 has an axis of rotation co-incident with the central axis of the chamber 9, and a radius slightly smaller than that of the interior of the chamber 9, so that there is a small gap between the inner side wall of the chamber 9, and the outer surface of the drum. In the preferred embodiment, the drum is substantially 100 mm diameter. The drum is connected to a motor 12 mounted on the side of the mulcher 1, as shown in FIG. 1. The drum 14 is a generally cylindrical shape, having two wedge-shaped cut-out sections 16 on opposed sides of the cylinder, running lengthways. Cutting blades 17 are connected to the drum 14 next to the cut-out sections, on the trailing side of the cut-out sections, running the length of the drum 14. As shown best in FIG. 8, the cutting blades 17 of the drum contain pockets under the blades 17 which are used to collect cut chippings from the base block/anvil but also include pockets of air. Clogging/bridging of a screen starts when the particles free fall through the screen, which can lead to a build-up or back-up, which in turn leads to full blocking. The air in conjunction with the drum speed assists clearance of the chippings, with the screen cleared by the cutting blade on the inner surface and blasting debris through the screen using air and centrifugal force

The drum in this embodiment is substantially approximately 100 mm in diameter. The drum and motor are configured so that for this size of drum, the running speed is around substantially eighteen meters per second (measured on the perimeter of the drum) A bigger drum can have a higher ‘in use’ speed of up to substantially thirty-six meters per second.

As shown in FIGS. 8 to 10, a base block or anvil 15 is located inside the chipper unit chamber 9, against the side wall of the chipper unit 3, directly adjacent to the lower side or edge of the entry aperture, and extending out from the perimeter of the drum at an angle. As mulching material enters the chamber 9 via the hopper 2, and as the drum 14 rotates, the blades 17 of the drum 14 hit this material as the material enters the chamber and the drum rotates, and chop it against/directly adjacent to, the upper edge of the anvil 15, so that it is cut and mulched into small fragments.

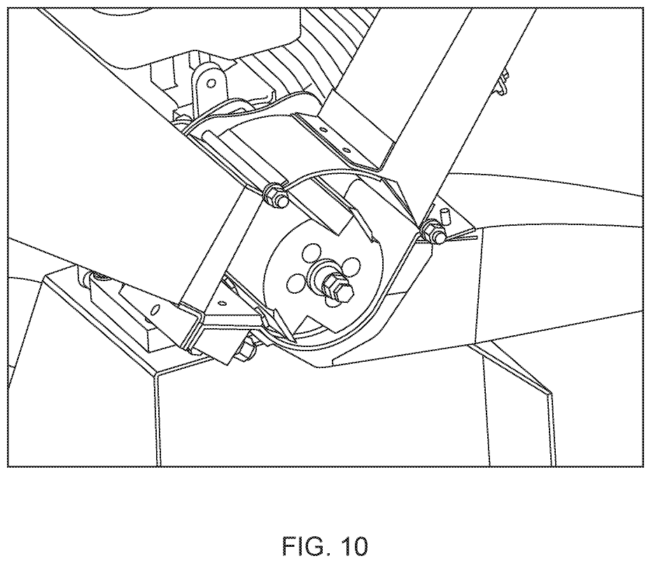

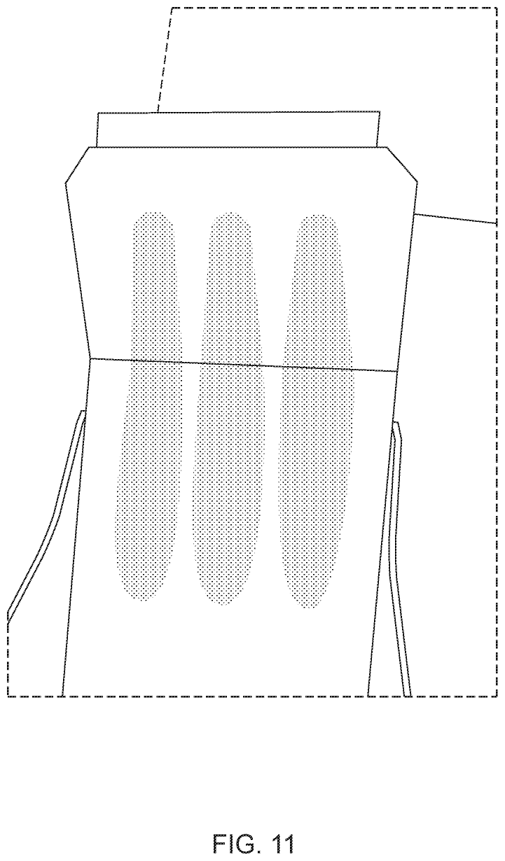

As shown in FIGS. 8, 9, and 10, the chipper unit 3 further comprises a discharge grid 13, located so that it extends around and forms part of the lower wall of the chamber 9, extending around substantially one-third of the perimeter or circumference of the chamber 9. As shown in FIGS. 8 and 10, the chamber and lower discharge chute 5 are formed and connected so that the entry aperture of the lower discharge chute 5 extends around and is directly adjacent to the grid 13, with the wall of the lower discharge chute 5 separated from the grid 13 by a gap.

The discharge grid 13 comprises a curved plate, curving to generally follow the curve of the inner wall of the chamber 9 and the outer path of the drum as the drum rotates. Four slots 11 are formed in the exit grid, aligned so that these are substantially parallel to the direction of travel of the drum, the slots formed generally evenly across the width of the plate. In use the blades 17 are directly adjacent to and follow the curve of the discharge grid very closely. The blades drive the mulched/chopped material through the slots as the drum rotates, and the blades assist with keeping the slots clear of blockages or similar, by continuously cutting any material on the inner side of the grid, and by actively pushing cut material through the slots 11.

This arrangement allows organic matter from the cutting head/drum 14 to be discharged through the slots directly. The chopped/mulched material is pushed through the slots by the rotational action of the drum 14, and does not require gravity to freefall through the grid. This allows the overall size of the grid 13 to be small—around half the size of the known, prior art grids of for example FIG. 2, which are larger and extend further around the perimeter of the chamber.

The high speed of the drum and the direction and length of the slots 11 acts to help force the chippings down the lower discharge chute 5. Mulched material is forced through the slots in the screen or grid 13. The grid 13 is cleared by the movement of the cutting blade across the inner surface thereof, and by forcibly pushing the cut material through the screen using the force of the movement of air and centrifugal force from rotation of the cutting head/drum 14. As shown in FIG. 11, the material is moved with sufficient force to scour the inner face of the lower discharge chute 5. This contrasts with known chippers, where the chippings drop under gravity through the gaps in the discharge plate when they are sufficiently small. This can lead to backing up and blockages, which require the machine to be stopped and manually cleared before operations can restart. The length of the grooves combined with the high speed of the drum of the mulcher 1 of the invention help to prevent blockages. This also allows an angled or directional discharge chute to be used, such as the lower discharge chute 5, where the chute is offset from directly vertically below the grid. The cut material will be driven sideways along the discharge chute rather than falling directly downwards under gravity, which requires collection of the material from directly under the grid, and constant clearing of this space to make room for new material.

The elongate slots 11 have the further advantage that the cutting produced are long and thin. This type of cutting breaks down better for mulch.

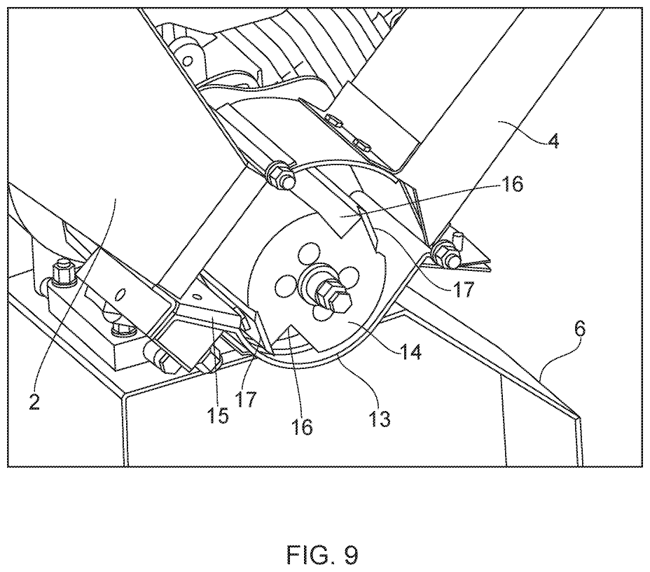

The grid 13 can be removed and changed for grids of different configurations, having a different arrangement of slots, and/or slots of different sizes. The grid can also be swapped for a blanking plate (as shown in the configuration of FIG. 9) so that only the upper discharge hopper is used for the ejection of mulched material, for example where discharge at a higher level is required-into a high-walled bin or over a barrier such as a fence or wall, for example.

Both the upper and the lower discharge chutes 4, 5 can be used simultaneously as shown in the configuration of FIG. 10. If both are used simultaneously, then lighter/smaller material will tend to be driven further around the drum, and will be discharged through the upper discharge chute. Again, the upper part can be blocked off with a blanking plate so that only the lower part is used, this configuration shown in FIG. 8. However, using two chutes in this way allows the simultaneous creation of both larger chips (via the lower discharge chute) and smaller chips. Bigger chips are preferred for uses such as weed prevention, and smaller chips are preferred for organic matter mulch.

A mulcher as described and shown can be used as a green-waste shredder for shredding garden waste, prunings, flowers, branches, leaves, agricultural crops, foliage etc. However, in addition to this, it can be used for mulching card, cartons and paper.

The mulcher of the present invention also offers an advantage over known types of shredding. In most cases, shredding involves cutting along the grain of the cut material (e.g. when branches are fed along a hopper chute they are fed lengthways, and the cutting blades on the shredder are generally aligned in the same plane), and this creates long thin needles as the end product. This occurs more so with larger items such as branches where shredding creates an end product that comprises long thin branch fibres which are then required to fit through a screen. The mulcher of the present invention drives this type of end product through a longer, thinner slot, which assists with preventing blockages. This also ensures that the mulcher self-cleans as it operates and mulches.

Due to the greater speed of the material as it exits the cutting area, the exit chute can be directed upwards or downwards, with the flow of material aimed directly into a sack or container, or into a wheel barrow.

1. A mulcher, comprising:
a hopper, having an inlet end and an outlet end, the hopper configured to receive vegetative debris via the inlet end;
a chipper unit having an outer casing and an inlet passing therethrough, the inlet connected to the hopper outlet end to receive the vegetative debris within the casing, the chipper unit further comprising a cutting means located within the casing and configured to chip and/or mulch vegetative debris within the chipper unit;
an outlet grid, the chipper unit and outlet grid configured so that the outlet grid forms an outlet for the vegetative debris within the casing, the outlet grid and cutting means mutually configured so that the grid is located substantially directly adjacent to the cutting means in use, the cutting means configured so that in use at least part of the vegetative debris is forced through the outlet grid.

2. The mulcher as claimed in claim 1 wherein the outlet grid comprises a plate with a plurality of elongate slots formed therethrough.

3. The mulcher as claimed in claim 2 wherein the elongate slots are formed to substantially follow the perimeter of the casing.

4. The mulcher as claimed in claim 2 wherein four substantially identical slots are formed across the width of the plate.

5. The mulcher as claimed in claim 1 wherein the cutting means comprises at least one rotating blade having an edge aligned substantially parallel to the axis of rotation, and a base block located within the chipper unit and configured so that vegetative debris moves over the base block into the blade(s), the blade(s) rotating directly adjacent to the base block.

6. The mulcher as claimed in claim 5 wherein the cutting means further comprises a rotating drum having a plurality of blades at the perimeter thereof.

7. The mulcher as claimed in claim 1 wherein the outlet grid extends substantially one-third of the distance around the perimeter of the chipper unit.

8. The mulcher as claimed in claim 1 wherein the outlet grid is located on the chipper unit so as to face at least partly downwards.

9. The mulcher as claimed in claim 1 wherein the outer casing of the chipper unit further comprises an upwardly-facing upper discharge aperture.

10. The mulcher as claimed in claim 9 wherein the discharge aperture is configured so that a blanking plate can be connected to the chipper unit to block the discharge aperture.

11. The mulcher as claimed in claim 1 wherein the outlet grid and chipper drum are configured so that the outlet grid can be removed and replaced with a blanking plate.
